(19) United States
(12) Patent Application Publication
(10) Pub. No.: US 2025/0372906 A1
(43) Pub. Date: Dec. 4, 2025

(54) ELECTRICAL CONNECTOR ASSEMBLY AND ELASTIC TERMINAL THEREOF

(71) Applicant: Cheng Uei Precision Industry Co., Ltd., New Taipei City (TW)

(72) Inventors: Chuan Hung Lin, New Taipei City (TW); Sheng Nan Yu, New Taipei City (TW)

(21) Appl. No.: 18/959,813

(22) Filed: Nov. 26, 2024

(30) Foreign Application Priority Data
May 28, 2024 (CN) 202421190577.9

(51) Int. Cl. H01R 13/11; H01R 13/424

(52) U.S. Cl. CPC H01R 13/11; H01R 13/424

(57) ABSTRACT

An electrical connector assembly includes a socket connector, and a plug connector docked with the socket connector. The socket connector includes an insulating housing defining a power terminal groove and an elastic terminal groove longitudinally penetrating through the insulating housing, an elastic terminal fastened in the elastic terminal groove, and a power terminal fastened in the power terminal groove. The plug connector includes an insulation body defining a power terminal hole and an elastic terminal hole longitudinally penetrating through the insulation body, the elastic terminal fastened in the elastic terminal hole, and the power terminal fastened in the power terminal hole.

### CROSS REFERENCE TO RELATED APPLICATIONS

The present application is based on, and claims priority from, China Patent Application No. 202421190577.9, filed May 28, 2024, the disclosure of which is hereby incorporated by reference herein in its entirety.

### BACKGROUND OF THE INVENTION

### Field of the Invention

The present invention generally relates to an electrical connector assembly, and more particularly to an electrical connector assembly which includes an elastic terminal and is capable of transmitting power or signals in a stable manner, and the elastic terminal of the electrical connector assembly improving a transmission stability.

### Description of Related Art

Generally, a conventional electrical connector assembly is provided between an electronic device and an electronic peripheral device for transmitting power or signals. The conventional electrical connector assembly includes a first terminal and a second terminal matched with the first terminal. The second terminal is connected to the first terminal. A contacting condition between the first terminal and the second terminal, and a contacting area between the first terminal and the second terminal directly affects an impedance of the conventional electrical connector assembly.

However, when the contacting condition between the first terminal and the second terminal is poor, or the contacting area between the first terminal and the second terminal is too small, the impedance of the conventional electrical connector assembly will be increased, so that a transmission efficiency of the conventional electrical connector assembly is affected, or an overheating phenomenon of the conventional electrical connector assembly is even caused.

Therefore, it is necessary to provide an electrical connector assembly which includes an elastic terminal and is capable of transmitting power or signals in a stable manner, and the elastic terminal of the electrical connector assembly improves a transmission stability.

### BRIEF SUMMARY OF THE INVENTION

An object of the present invention is to provide an elastic terminal, comprising: a base portion; and a flexible structure extended frontward from a front end of the base portion, the flexible structure having an upper flexible arm extended frontward from a front edge of a top of the base portion, a lower flexible arm extended frontward from a front edge of a bottom of the base portion, and a side flexible arm extended frontward from a front edge of each side of the base portion, a middle of each of the upper flexible arm, the lower flexible arm and the side flexible arm being bent inward to form a contacting portion; and wherein the base portion has a top plate, two side plates vertically extended downward from two side edges of the top plate, and a bottom plate connected with two bottom edges of the two side plates; wherein the bottom plate is extended from a bottom of one side plate, an engagement edge of the bottom plate engages with an engagement edge of a bottom of the other side plate; wherein each side of the base portion has two side flexible arms, the two side flexible arms of each side of the base portion are disposed along an up-down direction, and the two side flexible arms of each side of the base portion are disposed along the up-down direction.

Another object of the present invention is to provide an electrical connector assembly, comprising: a socket connector having an insulating housing, the insulating housing having a power terminal groove and an elastic terminal groove longitudinally penetrating through the insulating housing, an elastic terminal fastened in the elastic terminal groove, the elastic terminal having a base portion shown as a rectangular tube shape, and a flexible structure extended frontward from a front end of the base portion, the flexible structure having an upper flexible arm extended frontward from a front edge of a top of the base portion, a lower flexible arm extended frontward from a front edge of a bottom of the base portion, and a side flexible arm extended frontward from a front edge of each side of the base portion, a middle of each of the upper flexible arm, the lower flexible arm and the side flexible arm being bent inward to form a contacting portion, and a power terminal fastened in the power terminal groove, the power terminal having a connecting portion; and a plug connector docked with the socket connector, the plug connector having an insulation body, the insulation body having a power terminal hole and an elastic terminal hole longitudinally penetrating through the insulation body, the elastic terminal fastened in the elastic terminal hole, the elastic terminal having the base portion shown as the rectangular tube shape, and the flexible structure extended frontward from the front end of the base portion, the flexible structure having the upper flexible arm extended frontward from the front edge of the top of the base portion, the lower flexible arm extended frontward from the front edge of the bottom of the base portion, and the side flexible arm extended frontward from the front edge of each side of the base portion, the substantial middle of each of the upper flexible arm, the lower flexible arm and the side flexible arm being bent inward to form the contacting portion, and the power terminal fastened in the power terminal hole, the power terminal having the connecting portion, wherein the connecting portion of the power terminal of the socket connector is inserted into an inside of the flexible structure of the elastic terminal of the plug connector to make the connecting portion of the power terminal of the socket connector electrically connected with the contacting portions of the flexible structure of the elastic terminal of the plug connector, and the connecting portion of the power terminal of the plug connector is inserted into the inside of the flexible structure of the elastic terminal of the socket connector to make the connecting portion of the power terminal of the plug connector electrically connected with the contacting portions of the flexible structure of the elastic terminal of the socket connector.

Another object of the present invention is to provide an electrical connector assembly, comprising: a socket connector having an insulating housing, the insulating housing having a power terminal groove, two signal terminal grooves and an elastic terminal groove longitudinally penetrating through the insulating housing, the signal terminal grooves disposed between the power terminal groove and the elastic terminal groove, an elastic terminal fastened in the elastic terminal groove, the elastic terminal having a base portion shown as a rectangular tube shape, and a flexible structure extended frontward from a front end of the base portion, the flexible structure having an upper flexible arm extended frontward from a front edge of a top of the base portion, a lower flexible arm extended frontward from a front edge of a bottom of the base portion, and a side flexible arm extended frontward from a front edge of each side of the base portion, a substantial middle of each of the upper flexible arm, the lower flexible arm and the side flexible arm being bent inward to form a contacting portion, a pair of signal terminals received in the two signal terminal grooves, and a power terminal fastened in the power terminal groove, the power terminal having a connecting portion; and a plug connector docked with the socket connector, the plug connector having an insulation body, the insulation body having a power terminal hole, two signal terminal holes and an elastic terminal hole longitudinally penetrating through the insulation body, the signal terminal holes disposed between the power terminal hole and the elastic terminal hole, the elastic terminal fastened in the elastic terminal hole, the elastic terminal having the base portion shown as the rectangular tube shape, and the flexible structure extended frontward from the front end of the base portion, the flexible structure having the upper flexible arm extended frontward from the front edge of the top of the base portion, the lower flexible arm extended frontward from the front edge of the bottom of the base portion, and the side flexible arm extended frontward from the front edge of each side of the base portion, the substantial middle of each of the upper flexible arm, the lower flexible arm and the side flexible arm being bent inward to form the contacting portion, the pair of the signal terminals received in the two signal terminal holes, and the power terminal fastened in the power terminal hole, the power terminal having the connecting portion, wherein the signal terminals of the socket connector are matched with the signal terminals of the plug connector; wherein the connecting portion of the power terminal of the socket connector is inserted into an inside of the flexible structure of the elastic terminal of the plug connector to make the connecting portion of the power terminal of the socket connector electrically connected with the contacting portions of the flexible structure of the elastic terminal of the plug connector, and the connecting portion of the power terminal of the plug connector is inserted into the inside of the flexible structure of the elastic terminal of the socket connector to make the connecting portion of the power terminal of the plug connector electrically connected with the contacting portions of the flexible structure of the elastic terminal of the socket connector, the pair of the signal terminals of the socket connector are electrically connected to the pair of the signal terminals of the plug connector.

As described above, the electrical connector assembly includes the socket connector, and the plug connector docked with the socket connector. The elastic terminal and the power terminal of the socket connector are embedded into the socket connector, and the elastic terminal and the power terminal of the plug connector are embedded into the plug connector. The front end of the elastic terminal has the flexible structure. The flexible structure has the upper flexible arm, the lower flexible arm and a plurality of the side flexible arms, and the substantial middle of each of the upper flexible arm, the lower flexible arm and the two side flexible arms is bent inward to form the contacting portion, so the power terminal of the socket connector is inserted into the flexible structure of the elastic terminal of the plug connector to make the power terminal of the socket connector electrically connected with the contacting portions of the flexible structure of the elastic terminal of the plug connector, and the power terminal of the plug connector is inserted into the flexible structure of the elastic terminal of the socket connector to make the power terminal of the plug connector electrically connected with the contacting portions of the flexible structure of the elastic terminal of the socket connector. In that case, an electrical contacting area between the socket connector and the plug connector is increased to reduce a contacting impedance and avoid causing an overheating problem. As a result, the electrical connector assembly is capable of transmitting power or signals in a stable manner, and the elastic terminal of the electrical connector assembly improves a transmission stability.

### BRIEF DESCRIPTION OF THE DRAWINGS

The present invention will be apparent to those skilled in the art by reading the following description, with reference to the attached drawings, in which:

FIG. 1 is a perspective view of an electrical connector assembly in accordance with the present invention;

FIG. 2 is an exploded view of the electrical connector assembly in accordance with the present invention;

FIG. 3 is a perspective view of an elastic terminal of the electrical connector assembly in accordance with the present invention;

FIG. 4 is another perspective view of the elastic terminal in accordance with the present invention;

FIG. 5 is a cross-sectional view of a power terminal and the elastic terminal along a line I-I of FIG. 1;

FIG. 6 is an exploded view of a socket connector of the electrical connector assembly in accordance with the present invention;

FIG. 7 is a perspective view of an insulating housing of the socket connector of the electrical connector assembly in accordance with the present invention;

FIG. 8 is an exploded view of a plug connector of the electrical connector assembly in accordance with the present invention; and

FIG. 9 is a perspective view of an insulation body of the plug connector in accordance with the present invention.

### DETAILED DESCRIPTION OF THE INVENTION

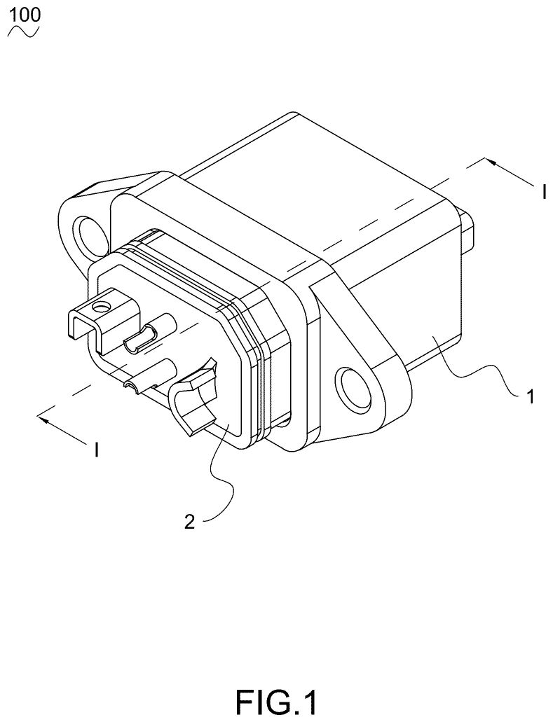

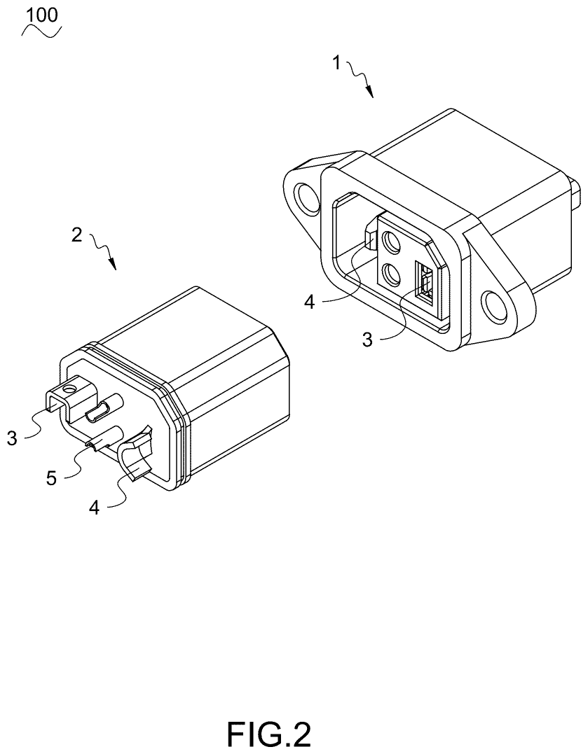

Referring to FIG. 1 and FIG. 2, an electrical connector assembly 100 in accordance with the present invention is shown. The electrical connector assembly 100 includes a socket connector 1, and a plug connector 2 matched with the socket connector 1. The plug connector 2 is docked with the socket connector 1. In order to describe more conveniently and more clearly, a docking end of the socket connector 1 is defined as a front end of the socket connector 1, a docking end of the plug connector 2 is defined as a front end of the plug connector 2, an end of the socket connector 1 which is opposite to the front end of the socket connector 1 is defined as a rear end of the socket connector 1, and an end of the plug connector 2 which is opposite to the front end of the plug connector 2 is defined as a rear end of the plug connector 2.

Referring to FIG. 2, each of the socket connector 1 and the plug connector 2 includes an elastic terminal 3, a power terminal 4 and a pair of signal terminals 5. The elastic terminal 3, the power terminal 4 and the pair of the signal terminals 5 of the socket connector 1 are embedded into the socket connector 1. The elastic terminal 3, the power terminal 4 and the pair of the signal terminals 5 of the plug connector 2 are embedded into the plug connector 2. The elastic terminal 3 of the socket connector 1 is electrically connected to the power terminal 4 of the plug connector 2. The power terminal 4 of the socket connector 1 is electrically connected to the elastic terminal 3 of the plug connector 2. The pair of the signal terminals 5 of the socket connector 1 are electrically connected to the pair of the signal terminals 5 of the plug connector 2.

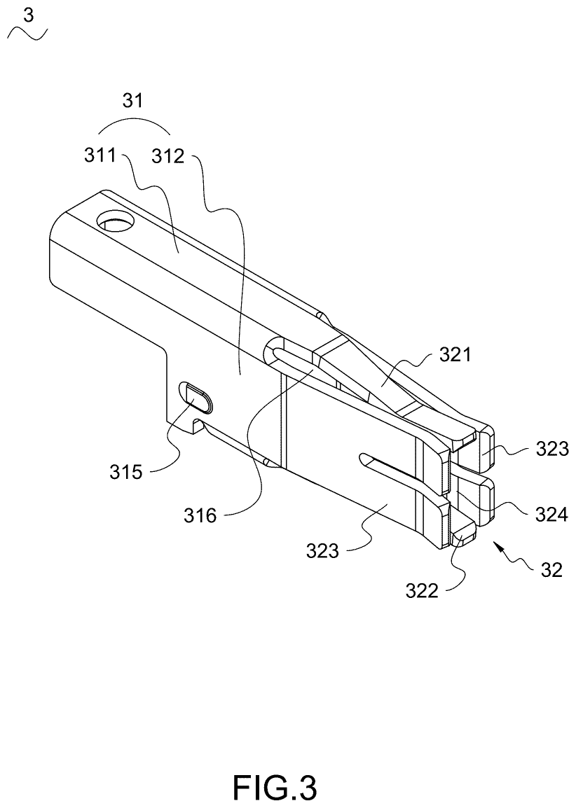

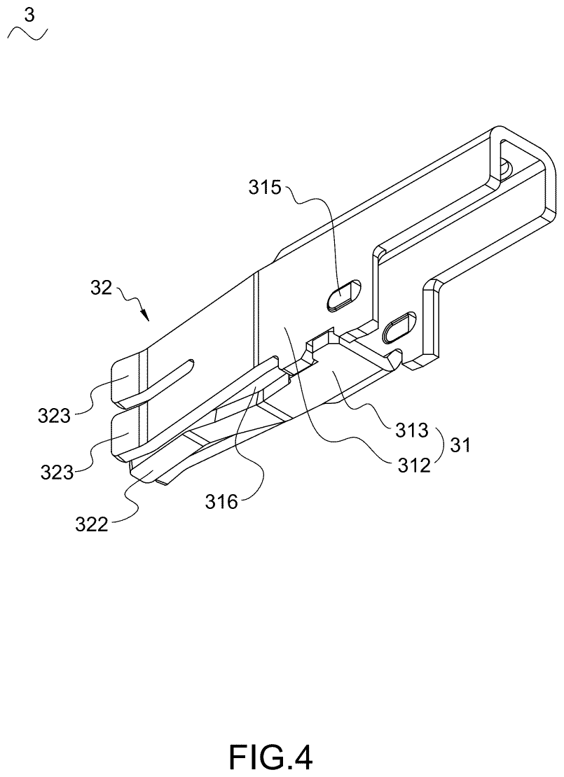

Referring to FIG. 3 to FIG. 5, the elastic terminal 3 is formed by stamping and bending a metal sheet. The elastic terminal 3 has a base portion 31, and a flexible structure 32 extended frontward from a front end of the base portion 31. The base portion 31 is shown as a rectangular tube shape. The base portion 31 has a top plate 311, two side plates 312 vertically extended downward from two side edges of the top plate 311, and a bottom plate 313 connected with two bottom edges of the two side plates 312.

A front end of the elastic terminal 3 has the flexible structure 32. The flexible structure 32 has an upper flexible arm 321 extended frontward from a front edge of a top of the base portion 31, a lower flexible arm 322 extended frontward from a front edge of a bottom of the base portion 31, and a side flexible arm 323 extended frontward from a front edge of each side of the base portion 31. Each side of the base portion 31 has two side flexible arms 323. A substantial middle of each of the upper flexible arm 321, the lower flexible arm 322 and the side flexible arm 323 is bent inward to form a contacting portion 324. The upper flexible arm 321 is slantwise extended frontward and downward, and then slantwise extended frontward and upward from a front edge of the top plate 311, the lower flexible arm 322 is slantwise extended frontward and upward, and then slantwise extended frontward and downward from a front edge of the bottom plate 313, and a plurality of the side flexible arms 323 are slantwise extended inward and frontward, and then slantwise extended frontward and outward from two front edges of the two side plates 312. Specifically, an upper portion and a lower portion of the front edge of each side plate 312 slantwise extend inward and frontward, and then slantwise extend frontward and outward to form the two side flexible arms 323. A quantity of the plurality of the side flexible arms 323 is four.

The upper flexible arm 321 and the lower flexible arm 322 are disposed symmetrical to each other. The side flexible arm 323 of one side of the base portion 31 is symmetrical to the side flexible arm 323 of the other side of the base portion 31. The two side flexible arms 323 of each side of the base portion 31 are disposed along an up-down direction, and the two side flexible arms 323 of each side of the base portion 31 are disposed along the up-down direction.

Each side plate 312 has the two side flexible arms 323. The two side flexible arms 323 of each side plate 312 are aligned along the up-down direction. The two side flexible arms 323 of one side plate 312 are opposite to the two side flexible arms 323 of the other side plate 312. The two side flexible arms 323 of the one side plate 312 are symmetrical to the two side flexible arms 323 of the other side plate 312. A substantial middle of each of the upper flexible arm 321, the lower flexible arm 322 and the plurality of the side flexible arms 323 is bent inward to form the contacting portion 324, so that the elastic terminal 3 has six contacting portions 324 in total.

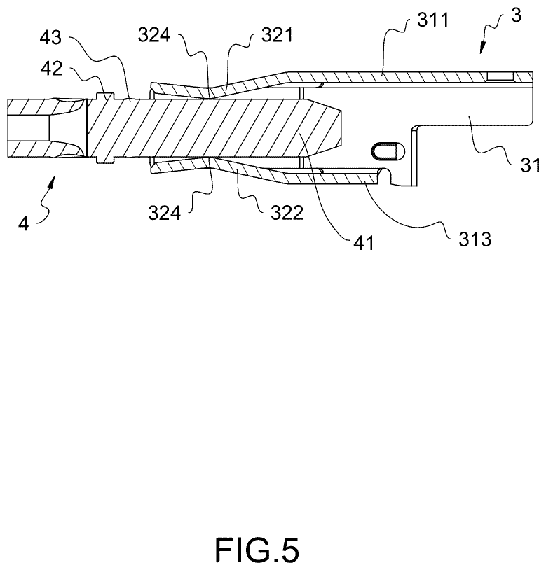

Referring to FIG. 5, the power terminal 4 has a connecting portion 41, a blocking portion 42 and a barb 43. Specifically, the power terminal 4 has two blocking portions 42 and two barbs 43. The connecting portion 41 is formed in a rectangular board shape. The connecting portion 41 is formed at a front end of the power terminal 4. The connecting portion 41 projects into an inside of the flexible structure 32 of the elastic terminal 3 to be electrically connected with the contacting portions 324 of the elastic terminal 3. The blocking portion 42 and the barb 43 are protruded outwardly from an outer surface of the power terminal 4. Two rears of two sides of the outer surface of the power terminal 4 protrude outward to form the two barbs 43. The two rears of the two sides of the outer surface of the power terminal 4 protrude outward to form the two blocking portions 42. The two barbs 43 are located in front of the two blocking portions 42.

With reference to FIG. 1 to FIG. 5, therefore, when the plug connector 2 is docked with the socket connector 1, the socket connector 1 is connected to the plug connector 2. The connecting portion 41 of the power terminal 4 of the socket connector 1 is inserted into an inside of the flexible structure 32 of the elastic terminal 3 of the plug connector 2 to make the connecting portion 41 of the power terminal 4 of the socket connector 1 electrically connected with the contacting portions 324 of the flexible structure 32 of the elastic terminal 3 of the plug connector 2, and the connecting portion 41 of the power terminal 4 of the plug connector 2 is inserted into the inside of the flexible structure 32 of the elastic terminal 3 of the socket connector 1 to make the connecting portion 41 of the power terminal 4 of the plug connector 2 electrically connected with the contacting portions 324 of the flexible structure 32 of the elastic terminal 3 of the socket connector 1. The contacting portions 324 of the elastic terminal 3 abut against the connecting portion 41 of the power terminal 4, so that the flexible structure 32 expands outward to be deformed along the outer surface of the power terminal 4, and a larger electrical contacting area between the power terminal 4 and the elastic terminal 3 is formed. The larger electrical contacting area which is formed between the power terminal 4 and the elastic terminal 3 reduces a contacting impedance in a process of transmitting a current so as to avoid an overheating problem, and accordingly, a signal transmission stability of the electrical connector assembly 100 is improved.

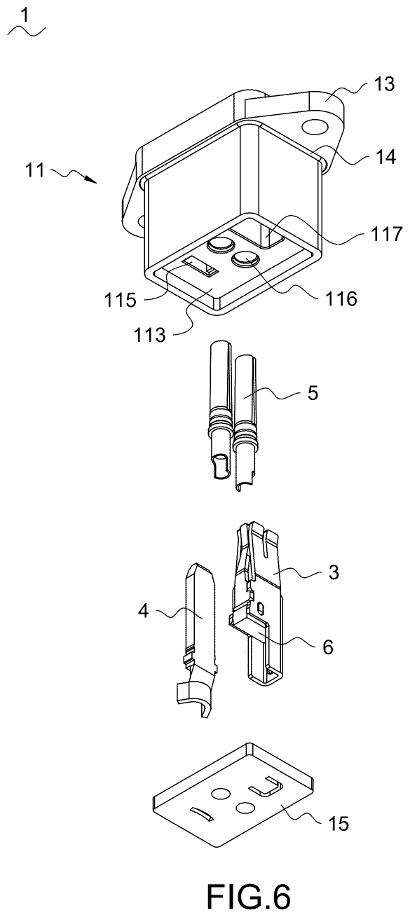

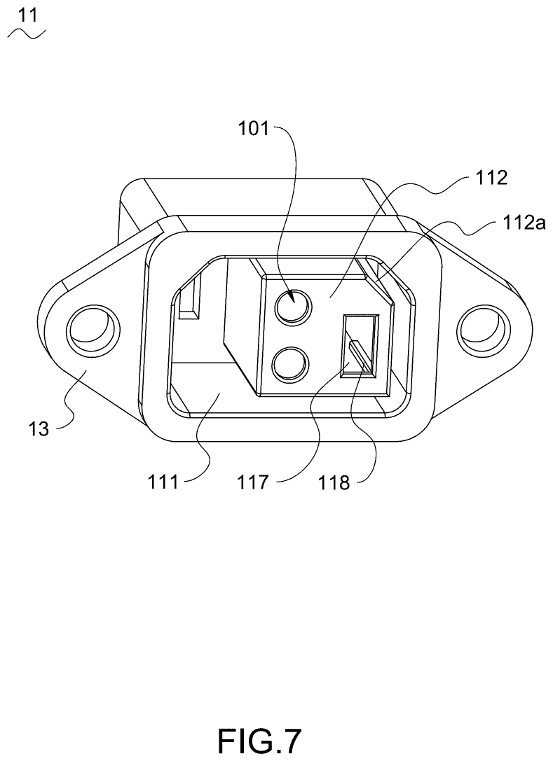

Referring to FIG. 6 and FIG. 7, the socket connector 1 includes an insulating housing 11. The insulating housing 11 is made of an insulating material. The insulating housing 11 is formed in a rectangular shape. Two upper portions of two sides of the insulating housing 11 protrude outward to form two assembling portions 13, respectively for being assembled with an electronic device (not shown). The two assembling portions 13 are shown as two lug shapes. A middle of a front surface of the insulating housing 11 is recessed inward to form a receiving space 111. One side of a rear wall of the receiving space 111 protrudes frontward to form a docking portion 112 projecting into the receiving space 111. A middle of a rear surface of the insulating housing 11 is recessed inward to form a locating groove 113.

The socket connector 1 further includes a sealing ring 14 and a gel body 15. The sealing ring 14 is mounted around a peripheral surface of the front end of the insulating housing 11. The sealing ring 14 is located behind the two assembling portions 13. The gel body 15 is coated at a rear end of the insulating housing 11. The gel body 15 is coated in the locating groove 113 to enclose rear ends of the elastic terminal 3, the power terminal 4, and the two signal terminals 5 of the socket connector 1. The gel body 15 and the sealing ring 14 together fill in gaps between the socket connector 1 and the electronic device (not shown) to achieve a waterproof effect.

In addition, the insulating housing 11 has a plurality of terminal openings 101 longitudinally penetrating through the insulating housing 11 and extending to the locating groove 113. The plurality of the terminal openings 101 are communicated with the locating groove 113. The plurality of the terminal openings 101 pass through the docking portion 112 and the rear wall of the receiving space 111. The plurality of the terminal openings 101 extend from the front end of the insulating housing 11 to the locating groove 113.

The plurality of the terminal openings 101 includes a power terminal groove 115, two signal terminal grooves 116 and an elastic terminal groove 117. The power terminal groove 115 longitudinally penetrates through the rear wall of the receiving space 111 and extends to the locating groove 113. The two signal terminal grooves 116 longitudinally penetrate through the docking portion 112 and the rear wall of the receiving space 111. The elastic terminal groove 117 longitudinally penetrates through the docking portion 112 and the rear wall of the receiving space 111. The insulating housing 11 define the power terminal groove 115, the two signal terminal grooves 116 and the elastic terminal groove 117 longitudinally penetrating through the insulating housing 11.

The two signal terminal grooves 116 are located between the power terminal groove 115 and the elastic terminal groove 117. The power terminal groove 115 is shown as a rectangle shape. Each signal terminal groove 116 is shown as a circle shape. The two signal terminal grooves 116 are arranged along the up-down direction. The two signal terminal grooves 116 are aligned along the up-down direction. The elastic terminal groove 117 is rectangular. The elastic terminal groove 117 extends to the locating groove 113. The pair of the signal terminals 5 are received in the two signal terminal grooves 116.

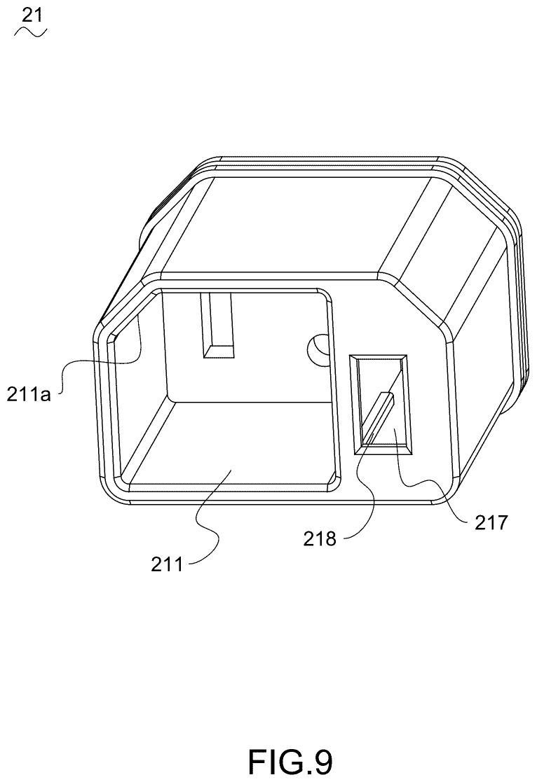

Referring to FIG. 6 to FIG. 9, the plug connector 2 further includes an insulation body 21 and a glue body 23. The insulation body 21 is formed in a rectangular hollow shape, and the insulation body 21 is made of the insulating material. A front end of the insulation body 21 is matched with the receiving space 111. The front end of the insulation body 21 is received in the receiving space 111. The glue body 23 is coated to a rear end of the insulation body 21.

One side of a front surface of the insulation body 21 is recessed inward to form a docking groove 211. An upper inner portion of the docking groove 211 slantwise extends downward and outward to form an internal guiding bevel 211a. An upper outer portion of the docking portion 112 slantwise extends downward and outward to form an external guiding bevel 112a. The docking portion 112 is inserted into the docking groove 211. The external guiding bevel 112a is matched with the internal guiding bevel 211a, so that a cross-sectional shape of the docking groove 211 is corresponding to a cross-sectional shape of the docking portion 112 to avoid a wrong insertion direction of the user.

A middle of a rear surface of the insulation body 21 is recessed inward to form a holding groove 213. The glue body 23 is coated in the holding groove 213 to surround the rear ends of the elastic terminal 3, the power terminal 4 and the two signal terminals 5 of the plug connector 2, so that external moistures are prevented from permeating into the plug connector 2 from a surface of the plug connector 2, specifically, the external moistures are prevented from permeating into the plug connector 2 from the rear surface of the plug connector 2.

Referring to FIG. 6 to FIG. 9, the insulation body 21 has a plurality of terminal holes 102 longitudinally penetrating through the insulation body 21 and extending to the holding groove 213. The plurality of the terminal holes 102 are communicated with the holding groove 213. The plurality of the terminal holes 102 include a power terminal hole 215, two signal terminal holes 216 and an elastic terminal hole 217. The power terminal hole 215 longitudinally penetrates through a rear wall of the docking groove 211 and extends to the holding groove 213. The two signal terminal holes 216 longitudinally penetrate through the rear wall of the docking groove 211. The elastic terminal hole 217 longitudinally penetrates through one side of the insulation body 21 and extends to the holding groove 213.

The insulation body 21 define the power terminal hole 215, the two signal terminal holes 216 and the elastic terminal hole 217 longitudinally penetrating through the insulation body 21. The elastic terminal hole 217 is aligned with the power terminal groove 115. The power terminal hole 215 is aligned with the elastic terminal groove 117. The two signal terminal holes 216 are disposed along the up-down direction. The two signal terminal holes 216 are aligned along the up-down direction. The two signal terminal holes 216 are located between the power terminal hole 215 and the elastic terminal hole 217. The power terminal hole 215 is rectangular. The elastic terminal hole 217 is rectangular. The pair of the signal terminals 5 are received in the two signal terminal holes 216.

Referring to FIG. 1 to FIG. 9, each side of the base portion 31 protrudes outward to form a bump 315. The two side plates 312 of the elastic terminal 3 protrude outward to form two bumps 315. Two rear ends of two outer edges of the upper flexible arm 321 are spaced from two fronts of two top edges of the two side plates 312 to form two notches 316. Two rear ends of two outer edges of the lower flexible arm 322 are spaced from two fronts of two bottom edges of the two side plates 312 to form the other two notches 316.

In order to make the elastic terminal 3 of the socket connector 1 stably received in the elastic terminal groove 117, the elastic terminal 3 of the socket connector 1 is fastened in the elastic terminal groove 117, the two bumps 315 of two sides of the base portion 31 of the elastic terminal 3 of the socket connector 1 contact with the two inner side walls of the elastic terminal groove 117, and the two bumps 315 of the two sides of the base portion 31 of the elastic terminal 3 of the socket connector 1 are interfered with the two inner side walls of the elastic terminal groove 117. An inner wall of the elastic terminal groove 117 protrudes inward to form a protruding rib 118. Specifically, four corners of the inner wall of the elastic terminal groove 117 protrude inward to form four protruding ribs 118. The four protruding ribs 118 of the elastic terminal groove 117 are combined with the four notches 316 of the socket connector 1. The four protruding ribs 118 of the elastic terminal groove 117 are received in the four notches 316 of the socket connector 1. The base portion 31 of the elastic terminal 3 of the socket connector 1 abuts against rear ends of the four protruding ribs 118 to locate the elastic terminal 3 of the socket connector 1 in the elastic terminal groove 117.

In order to make the elastic terminal 3 of the plug connector 2 in the elastic terminal hole 217 stably, the elastic terminal 3 is fastened in the elastic terminal hole 217, the two bumps 315 of the two sides of the base portion 31 of the elastic terminal 3 of the plug connector 2 contact with two sides of an inner wall of the elastic terminal hole 217, and the two bumps 315 of the two sides of the base portion 31 of the elastic terminal 3 of the plug connector 2 are interfered with the two sides of the inner wall of the elastic terminal hole 217. The inner wall of the elastic terminal hole 217 protrudes inward to form a convex rib 218. Specifically, four corners of the inner wall of the elastic terminal hole 217 protrude inward to form four convex ribs 218. The four convex ribs 218 of the plug connector 2 are combined with the four notches 316 of the elastic terminal 3 of the plug connector 2. The four convex ribs 218 of the plug connector 2 are received in the four notches 316 of the elastic terminal 3 of the plug connector 2. The base portion 31 of the elastic terminal 3 of the plug connector 2 abuts against rear ends of the four convex ribs 218 to locate the elastic terminal 3 of the plug connector 2 in the elastic terminal hole 217.

In order to to combine the power terminal 4 of the socket connector 1 with the insulating housing 11 of the socket connector 1 stably, the power terminal 4 is fastened in the power terminal groove 115, a top wall and a bottom wall of the power terminal groove 115 are exposed to a rear end of the power terminal groove 115, the two blocking portions 42 of the power terminal 4 of the socket connector 1 are retained at the rear end of the power terminal groove 115 by the top wall and the bottom wall of the power terminal groove 115, and the two barbs 43 of the power terminal 4 of the socket connector 1 abut against inner surfaces of the top wall and the bottom wall of the power terminal groove 115.

In order to combine the power terminal 4 of the plug connector 2 with the insulation body 21 of the plug connector 2 stably, the power terminal 4 is fastened in the power terminal hole 215, a top wall and a bottom wall of the power terminal hole 215 are exposed to a rear end of the power terminal hole 215, the two blocking portion 42 of the power terminal 4 of the plug connector 2 are retained at the rear end of the power terminal hole 215 by the top wall and the bottom wall of the power terminal hole 215, and the two barbs 43 of the power terminal 4 of the plug connector 2 abut against inner surfaces of the top wall and the bottom wall of the power terminal hole 215.

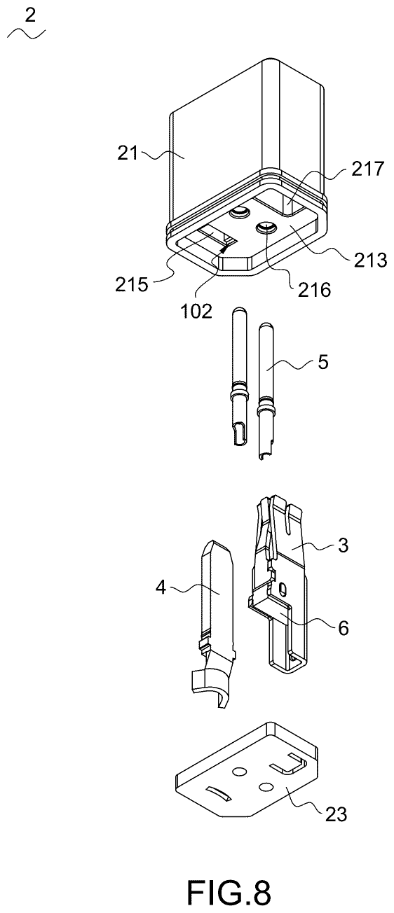

Referring to FIG. 6 and FIG. 8, in order to avoid the gel body 15 and the glue body 23 respectively permeate into the insulating housing 11 and the insulation body 21 during a gluing process, the electrical connector assembly 100 further includes two retaining blocks 6, the two retaining blocks 6 are respectively assembled into the inside of the elastic terminal 3 received in the elastic terminal groove 117 and the inside of the elastic terminal 3 received in the elastic terminal hole 217, specifically, the two retaining blocks 6 are respectively assembled into a rear end of the base portion 31 of the elastic terminal 3 received in the elastic terminal groove 117 and the rear end of the base portion 31 of the elastic terminal 3 received in the elastic terminal hole 217, and two outer surfaces of the two retaining blocks 6 are respectively attached to an inner surface of the rear end of the base portion 31 of the elastic terminal 3 received in the elastic terminal groove 117 and the inner surface of the rear end of the base portion 31 of the elastic terminal 3 received in the elastic terminal hole 217 to make the two retaining blocks 6 together with the rear ends of the base portions 31 of the two elastic terminals 3 received in the elastic terminal groove 117 and the elastic terminal hole 217 seal up a rear end of the elastic terminal groove 117 and a rear end of the elastic terminal hole 217.

As described above, the electrical connector assembly 100 includes the socket connector 1, and the plug connector 2 docked with the socket connector 1. The elastic terminal 3 and the power terminal 4 of the socket connector 1 are embedded into the socket connector 1, and the elastic terminal 3 and the power terminal 4 of the plug connector 2 are embedded into the plug connector 2. The front end of the elastic terminal 3 has the flexible structure 32. The flexible structure 32 has the upper flexible arm 321, the lower flexible arm 322 and the plurality of the side flexible arms 323, and the substantial middle of each of the upper flexible arm 321, the lower flexible arm 322 and the two side flexible arms 323 is bent inward to form the contacting portion 324, so the power terminal 4 of the socket connector 1 is inserted into the flexible structure 32 of the elastic terminal 3 of the plug connector 2 to make the power terminal 4 of the socket connector 1 electrically connected with the contacting portions 324 of the flexible structure 32 of the elastic terminal 3 of the plug connector 2, and the power terminal 4 of the plug connector 2 is inserted into the flexible structure 32 of the elastic terminal 3 of the socket connector 1 to make the power terminal 4 of the plug connector 2 electrically connected with the contacting portions 324 of the flexible structure 32 of the elastic terminal 3 of the socket connector 1. In that case, the electrical contacting area between the socket connector 1 and the plug connector 2 is increased to reduce the contacting impedance and avoid causing the overheating problem. As a result, the electrical connector assembly 100 is capable of transmitting power or signals in a stable manner, and the elastic terminal 3 of the electrical connector assembly 100 improves a transmission stability.

What is claimed is:

1. An elastic terminal, comprising:
a base portion; and
a flexible structure extended frontward from a front end of the base portion, the flexible structure having an upper flexible arm extended frontward from a front edge of a top of the base portion, a lower flexible arm extended frontward from a front edge of a bottom of the base portion, and a side flexible arm extended frontward from a front edge of each side of the base portion, a middle of each of the upper flexible arm, the lower flexible arm and the side flexible arm being bent inward to form a contacting portion; and
wherein the base portion has a top plate, two side plates vertically extended downward from two side edges of the top plate, and a bottom plate connected with two bottom edges of the two side plates;
wherein the bottom plate is extended from a bottom of one side plate, an engagement edge of the bottom plate engages with an engagement edge of a bottom of the other side plate;
wherein each side of the base portion has two side flexible arms, the two side flexible arms of each side of the base portion are disposed along an up-down direction, and the two side flexible arms of each side of the base portion are disposed along the up-down direction.

2. The elastic terminal as claimed in claim 1, wherein the upper flexible arm and the lower flexible arm are disposed symmetrical to each other, the side flexible arm of one side of the base portion is symmetrical to the side flexible arm of the other side of the base portion.

3. The elastic terminal as claimed in claim 1, wherein each side of the base portion protrudes outward to form a bump.

4. The elastic terminal as claimed in claim 1, wherein the upper flexible arm is slantwise extended frontward and downward, and then slantwise extended frontward and upward from a front edge of the top plate, the lower flexible arm is slantwise extended frontward and upward, and then slantwise extended frontward and downward from a front edge of the bottom plate, and a plurality of the side flexible arms are slantwise extended inward and frontward, and then slantwise extended frontward and outward from two front edges of the two side plates.

5. An electrical connector assembly, comprising:
a socket connector having
an insulating housing, the insulating housing having a power terminal groove and an elastic terminal groove longitudinally penetrating through the insulating housing,
an elastic terminal fastened in the elastic terminal groove, the elastic terminal having a base portion shown as a rectangular tube shape, and a flexible structure extended frontward from a front end of the base portion, the flexible structure having an upper flexible arm extended frontward from a front edge of a top of the base portion, a lower flexible arm extended frontward from a front edge of a bottom of the base portion, and a side flexible arm extended frontward from a front edge of each side of the base portion, a middle of each of the upper flexible arm, the lower flexible arm and the side flexible arm being bent inward to form a contacting portion, and
a power terminal fastened in the power terminal groove, the power terminal having a connecting portion; and
a plug connector docked with the socket connector, the plug connector having an insulation body, the insulation body having a power terminal hole and an elastic terminal hole longitudinally penetrating through the insulation body,
the elastic terminal fastened in the elastic terminal hole, the elastic terminal having the base portion shown as the rectangular tube shape, and the flexible structure extended frontward from the front end of the base portion, the flexible structure having the upper flexible arm extended frontward from the front edge of the top of the base portion, the lower flexible arm extended frontward from the front edge of the bottom of the base portion, and the side flexible arm extended frontward from the front edge of each side of the base portion, the substantial middle of each of the upper flexible arm, the lower flexible arm and the side flexible arm being bent inward to form the contacting portion, and
the power terminal fastened in the power terminal hole, the power terminal having the connecting portion,
wherein the connecting portion of the power terminal of the socket connector is inserted into an inside of the flexible structure of the elastic terminal of the plug connector to make the connecting portion of the power terminal of the socket connector electrically connected with the contacting portions of the flexible structure of the elastic terminal of the plug connector, and the connecting portion of the power terminal of the plug connector is inserted into the inside of the flexible structure of the elastic terminal of the socket connector to make the connecting portion of the power terminal of the plug connector electrically connected with the contacting portions of the flexible structure of the elastic terminal of the socket connector.

6. The electrical connector assembly as claimed in claim 5, wherein each side of the base portion protrudes outward to form a bump, the two bumps of two sides of the base portion of the elastic terminal of the socket connector contact with two inner side walls of the elastic terminal groove, and the two bumps of the two sides of the base portion of the elastic terminal of the socket connector are interfered with the two inner side walls of the elastic terminal groove, the two bumps of the two sides of the base portion of the elastic terminal of the plug connector contact with two sides of an inner wall of the elastic terminal hole, and the two bumps of the two sides of the base portion of the elastic terminal of the plug connector are interfered with the two sides of the inner wall of the elastic terminal hole.

7. The electrical connector assembly as claimed in claim 5, wherein the base portion has two side plates, two rear ends of two outer edges of the upper flexible arm are spaced from two fronts of two top edges of the two side plates to form two notches, two rear ends of two outer edges of the lower flexible arm are spaced from two fronts of two bottom edges of the two side plates to form the other two notches, four corners of an inner wall of the elastic terminal groove protrude inward to form four protruding ribs, the four protruding ribs of the elastic terminal groove are received in the four notches of the socket connector, four corners of an inner wall of the elastic terminal hole protrude inward to form four convex ribs, the four convex ribs of the plug connector are received in the four notches of the elastic terminal of the plug connector.

8. The electrical connector assembly as claimed in claim 5, wherein a front surface of the insulating housing is recessed inward to form a receiving space, one side of a rear wall of the receiving space protrudes frontward to form a docking portion projecting into the receiving space, a front end of the insulation body is matched with the receiving space, the front end of the insulation body is received in the receiving space, one side of a front surface of the insulation body is recessed inward to form a docking groove, the docking portion is inserted into the docking groove.

9. The electrical connector assembly as claimed in claim 8, wherein a middle of a rear surface of the insulating housing is recessed inward to form a locating groove, the power terminal groove longitudinally penetrates through a rear wall of the receiving space and extends to the locating groove, the elastic terminal groove longitudinally penetrates through the docking portion and the rear wall of the receiving space, the elastic terminal groove extends to the locating groove, the socket connector further includes a gel body, the gel body is coated in the locating groove.

10. The electrical connector assembly as claimed in claim 8, wherein a middle of a rear surface of the insulation body is recessed inward to form a holding groove, the elastic terminal hole longitudinally penetrates through one side of the insulation body and extends to the holding groove, the power terminal hole longitudinally penetrates through a rear wall of the docking groove and extends to the holding groove, the elastic terminal hole is aligned with the power terminal groove, the power terminal hole is aligned with the elastic terminal groove, the plug connector further includes a glue body, the glue body is coated in the holding groove.

11. The electrical connector assembly as claimed in claim 5, further comprising two retaining blocks, the two retaining blocks being respectively assembled into a rear end of the base portion of the elastic terminal received in the elastic terminal groove and the rear end of the base portion of the elastic terminal received in the elastic terminal hole, and two outer surfaces of the two retaining blocks being respectively attached to an inner surface of the rear end of the base portion of the elastic terminal received in the elastic terminal groove and the inner surface of the rear end of the base portion of the elastic terminal received in the elastic terminal hole to make the two retaining blocks together with the rear ends of the base portions of the two elastic terminals received in the elastic terminal groove and the elastic terminal hole seal up a rear end of the elastic terminal groove and a rear end of the elastic terminal hole.

12. An electrical connector assembly, comprising:
a socket connector having
an insulating housing, the insulating housing having a power terminal groove, two signal terminal grooves and an elastic terminal groove longitudinally penetrating through the insulating housing, the signal terminal grooves disposed between the power terminal groove and the elastic terminal groove,
an elastic terminal fastened in the elastic terminal groove, the elastic terminal having a base portion shown as a rectangular tube shape, and a flexible structure extended frontward from a front end of the base portion, the flexible structure having an upper flexible arm extended frontward from a front edge of a top of the base portion, a lower flexible arm extended frontward from a front edge of a bottom of the base portion, and a side flexible arm extended frontward from a front edge of each side of the base portion, a substantial middle of each of the upper flexible arm, the lower flexible arm and the side flexible arm being bent inward to form a contacting portion,
a pair of signal terminals received in the two signal terminal grooves, and
a power terminal fastened in the power terminal groove, the power terminal having a connecting portion; and
a plug connector docked with the socket connector, the plug connector having
an insulation body, the insulation body having a power terminal hole, two signal terminal holes and an elastic terminal hole longitudinally penetrating through the insulation body, the signal terminal holes disposed between the power terminal hole and the elastic terminal hole, the elastic terminal fastened in the elastic terminal hole, the elastic terminal having the base portion shown as the rectangular tube shape, and the flexible structure extended frontward from the front end of the base portion, the flexible structure having the upper flexible arm extended frontward from the front edge of the top of the base portion, the lower flexible arm extended frontward from the front edge of the bottom of the base portion, and the side flexible arm extended frontward from the front edge of each side of the base portion, the substantial middle of each of the upper flexible arm, the lower flexible arm and the side flexible arm being bent inward to form the contacting portion,
the pair of the signal terminals received in the two signal terminal holes, and
the power terminal fastened in the power terminal hole, the power terminal having the connecting portion,
wherein the signal terminals of the socket connector are matched with the signal terminals of the plug connector;
wherein the connecting portion of the power terminal of the socket connector is inserted into an inside of the flexible structure of the elastic terminal of the plug connector to make the connecting portion of the power terminal of the socket connector electrically connected with the contacting portions of the flexible structure of the elastic terminal of the plug connector, and the connecting portion of the power terminal of the plug connector is inserted into the inside of the flexible structure of the elastic terminal of the socket connector to make the connecting portion of the power terminal of the plug connector electrically connected with the contacting portions of the flexible structure of the elastic terminal of the socket connector, the pair of the signal terminals of the socket connector are electrically connected to the pair of the signal terminals of the plug connector.
